(19) United States
(12) Patent Application Publication
(10) Pub. No.: US 2024/0325962 A1
(43) Pub. Date: Oct. 3, 2024

(54) AIR FILTER ARRANGEMENT AND METHOD OF REPLACING SEVERAL FILTER ELEMENTS

(71) Applicant: Joseph Vögele AG, Ludwigshafen/Rhein (DE)

(72) Inventors: Bernhard ERDTMANN, Edingen Neckarhausen (DE); Stefan WEBER, Rödersheim-Gronau (DE); Johannes PONTIUS, Schmelz (DE); Jan RIFFEL, Mannheim (DE); Felix KEMPF, Mannheim (DE)

(73) Assignee: Joseph Vögele AG, Ludwigshafen/Rhein (DE)

(21) Appl. No.: 18/617,781

(22) Filed: Mar. 27, 2024

(30) Foreign Application Priority Data
Mar. 27, 2023 (EP) 23164329.7

(51) Int. Cl. B01D 46/88; B01D 46/00; B01D 46/10; B01D 46/52; B01D 46/62; B60H 3/06; E01C 19/48

(52) U.S. Cl. CPC B01D 46/88; B01D 46/0005; B01D 46/0038; B01D 46/10; B01D 46/521; B01D 46/62; B60H 3/0616; B01D 2265/028; B01D 2265/04; B01D 2271/02; B01D 2275/10; B01D 2275/40; B60H 2003/0691; E01C 19/48; E01C 2301/30

(57) ABSTRACT

The disclosure relates to an air filter arrangement for cleaning a bitumen-containing volume flow, comprising at least a first filter element and a second filter element, which are arranged as filter elements acting in succession for cleaning the bitumen-containing volume flow, wherein the first filter element and the second filter element are fixedly connected to one another. Furthermore, the disclosure relates to a method for carrying out an exchange of a plurality of filter elements.

### CROSS-REFERENCE TO RELATED APPLICATIONS

### Technical Field

This application claims foreign priority benefits under 35 U.S.C. § 119 (a)-(d) to European patent application number EP 23164329.7, filed Mar. 27, 2023, which is incorporated by reference in its entirety.

The present disclosure relates to an air filter arrangement and to a method of replacing a plurality of used filter elements.

### Background

In the not yet published European patent application no. 22 184 913.6, a fresh air device with a filter unit attached to it, which is configured to clean a bitumen-containing volume flow, is de-scribed for a road paver. The filter unit has a filter housing as well as several filter elements, which are accommodated individually in a predetermined sequence one behind the other in the filter housing. With such a multi-part structure, replacing the filter elements involves a relatively high level of effort. When replacing the filter, the filter housing must in fact first be opened using a suit-able tool. Then the respective filter elements must be removed piece by piece, that is, individually one after the other, and disposed of. Furthermore, before installing new filter elements, it is often necessary to clean the filter housing, in particular the receptacles provided for the respective filter elements. The new filter elements can then be installed individually one after the other to finally close the housing. In total, this results in several work steps that delay the actual installation process on the construction site. The time required for this leads in particular to undesirable down-times on the construction site, which can cause the installation material to cool down. Due to the handling of the filter replacement process described above, it can also occur that the new filter elements are installed in the housing in the wrong order, which means that the desired filter effect can no longer be achieved. When installing several individual filter elements, there is in particular the risk that a fine particle filter that is actually provided as a downstream filter stage is inadvertently installed as a pre-filter, i.e., as an inlet filter stage. At this point, a filter cake can easily form on the surface of the fine particle filter, which can clog the intake path. An incorrect order of the filter elements can therefore also have a negative effect on the fan unit connected to the filter unit.

### SUMMARY

An object of the disclosure is to provide a better manageable air filter arrangement for construction site use with regard to the problem described above, which can be reliably installed and dis-mantled on the construction site within a short time for cleaning a bitumen-containing volume flow.

This problem is solved by means of an air filter arrangement according to the disclosure and by means of a method according to the disclosure.

The disclosure relates to an air filter arrangement for cleaning a bitumen-containing volume flow, wherein the air filter arrangement comprises at least one first filter element and at least one second filter element, which are arranged as filter elements acting in succession for cleaning the bitumen-containing volume flow. According to the disclosure, the first filter element and the second filter element are firmly connected to one another. This results in a fixed connection of several filter elements to form a filter unit. Such a filter unit can be preferably used on a fresh air device on a road construction site to filter bitumen-containing vapors and/or aerosols from the air in several filter stages and to provide the purified air flow obtained from this as fresh air at a workplace.

In accordance with the disclosure, a connection is made between the two filter elements, by means of which the two filter elements are held together with a predetermined holding force. The two filter elements are thus not present as separate individual parts, but together form an inseparable unit. This means that the two filter elements, which may have different filter properties, can be removed and installed in one piece.

In the air filter arrangement according to the disclosure, the two filter elements are not present as individual filters arranged in series one behind the other in separate form. Rather, the air filter arrangement according to the disclosure forms a coherent composite of individual filter elements. As a result, the respective filter elements are better manageable together, can be removed in particular in one piece and can be replaced with new filter elements joined together according to the disclosure with little effort. This reduces the time required to replace filters on the construction site and makes filter replacement easier and less error-prone overall.

The fact that the two filter elements of the air filter arrangement according to the disclosure are firmly connected to one another also results in a compact overall structure of the air filter arrangement. Such a one-piece air filter arrangement consisting of several filter elements can be installed in a better way, especially in places that are difficult to access, for example behind a control panel or overhead.

Preferably, the two filter elements are connected to one another by a material bond, form-fit and/or force-fit connection. It would be conceivable to join the two filter elements together at their outer edges facing each other by fusing and by the resulting intermolecular or chemical bonding forces, if necessary by means of additives. In particular, a welding, soldering or adhesive connection joining the filter elements together could be considered for this purpose. Preferably, the first filter element and the second filter element are glued together. This allows the two filter elements to form a robust unit.

One variant provides that the edges of the respective filter elements facing each other and formed on the outside are glued together all around in an airtight manner. Separation points between the filter elements glued together in such a way do not need to provide any further sealing. An adhesive strip applied for this purpose can hold the two filter elements together such that they can only be separated by cutting the adhesive strip.

In particular, an airtight coating is formed at least in some areas by external walls of the joined filter elements. This coating fulfills the function of a filter housing so that no separate housing is required to attach the air filter arrangement. This means that the two filter elements form a housing for the air filter arrangement due to their combined shell surface.

It is conceivable that the air filter arrangement as a whole could be configured as a one-piece clip-on module for tool-free attachment to a fan unit. In particular, the air filter arrangement is a stable filter unit made up of several filter elements, which does not require a separate filter housing. In this case, the outer walls of the combined filter elements can themselves form the housing of the air filter arrangement. This reduces the amount of cleaning required on the construction site, as separate housing structures, in particular housings for receiving individual filter elements, always provide a surface for contamination. A clip-on module such as this can in particular be disposable.

According to one embodiment of the disclosure, the first filter element and/or the second filter element has a zigzag-shaped, undulating, rectangular, nub-shaped and/or pyramid-shaped filter mesh. This allows the filter surface of the filter element(s) to be enlarged. It would be conceivable for the first filter element and/or the second filter element to form a filter surface that is present as a filter profile with heights and depths. In the assembled state of both filter elements, the respective profiles can be aligned with each other such that their heights and depths are offset from each other. It would be conceivable that the filter profile is configured in the form of a nubby profile or a pyramid profile. A particularly large filter surface, despite limited installation space, is achieved if both filter elements have a zigzag-shaped, undulating, rectangular filter mesh and/or the filter profile described above. The filtering of aerosols from the bitumen-containing volume flow passing through them can be carried out reliably by the two filter elements in particular if their mutually facing filter structures are aligned offset to one another in the direction of the volume flow. This allows the filter effect to be maximized; in particular, aerosols that are not bound by the first filter element can be bound by the filter element positioned behind it.

In addition, the filter properties can be improved if the first filter element and/or the second filter element is an activated carbon filter. Aerosols can be bound particularly effectively by means of activated carbon contained in the filter elements.

Preferred filtration of the bitumen-containing volume flow results from the fact that the two filter elements are identical filter elements, that is, they have comparable filter properties, for example two zigzag-shaped activated carbon filters joined together. This also results in advantages for recycling.

It would be useful if the air filter arrangement included a third filter element as a pre-filter, which is firmly or detachably connected to the first and second filter elements, preferably glued to them. Regardless of whether the pre-filter is firmly or detachably connected to the two filter elements, it can be removed and installed in one piece together with the first and second filter elements. Such an air filter arrangement formed in three layers saves even more time during a filter replacement if it is manageable in one piece during installation and removal. Above all, this makes it easier to replace filters in places that are difficult to access, for example behind or underneath a console.

A robust unit consisting of the three individual filter elements is created in particular by gluing these filter elements together. Such a three-layer bonded unit consisting of the respective filter elements can be attached to a fan unit in one piece. However, it would be conceivable for the third filter element to be detachably coupled to the other two filter elements for long-term use, so that the third filter element used as a pre-filter can be replaced earlier than the other two filter elements.

One variant provides that the third filter element has a smooth surface. This allows the third filter element used as a pre-filter to be easily cleaned. For example, a film of coarse particles that has collected on the smooth surface, known as filter cake in specialist circles, can be easily wiped off the smooth surface. It would be conceivable for the third filter element to be a foam filter. Such a filter element can be used very well as a coarse particle filter at the foremost position of the air filter arrangement. As an alternative to a foam filter, a fleece filter could also be considered.

According to one embodiment of the disclosure, the respective filter elements are present as filter layers arranged one above the other. Accordingly, the air filter arrangement has a layered structure comprising several filter elements, resulting in a compact structure. In particular, the respective filter elements can be in the form of filter mats arranged one above the other.

Preferably, the air filter arrangement forms an inlet side and an outlet side, wherein a sealing element is provided on the inlet side and/or on the outlet side. The sealing element enables the air filter arrangement to be attached to a fan unit in a sealing manner. The sealing element is provided in particular as a rubber lip or rubber bead and can be glued to the edge of the externally positioned filter element, in particular to the edge of the externally positioned, zigzag-shaped activated carbon filter. In the case of a round filter shape, the sealing element can be provided as a rubber ring.

Preferably, the sealing element is configured in the form of a latching element for tool-free attachment to a fan housing. In this variant, the sealing element also has the function of serving as a fastening means for attaching the air filter arrangement.

One variant provides that the sealing element forms a tapered bead that can be pressed against a housing surface of a fan unit as a sealing lip. The sealing element can form a projection configured as a latching means or latching element that can be held against a housing projection of the fan unit when pulled. It would be conceivable for the sealing element to be pushed onto the filter element forming the outlet side by means of a press fit, in particular onto the zigzag-shaped activated carbon filter positioned at the outlet.

A particularly dimensionally stable air filter arrangement suitable for three-stage filtration results from the fact that the three interconnected filter elements form a shell surface as a result of their assembly, which is present as an airtight coating. This coating can be made of the same material as a material used for gluing the respective filter elements. Such a coating also serves as weather protection and ensures that no weather-related moisture accumulates in the filter elements. A coating formed by the joined shell surfaces of the three filter elements simultaneously forms a flow channel for the bitumen-containing air that is sucked in or blown through.

It would be conceivable for the airtight coating to be created by an outer mesh structure of the filter elements. The outer walls of the filter elements have a mesh structure with high impermeability, but can essentially be made of the same mesh material as the filter structure.

According to one embodiment, an externally formed, extended wall section of the central filter element is available as a receptacle for the filter element used as a pre-filter on the air filter arrangement. For example, a foam filter provided as a pre-filter could be placed in this receptacle with a press fit. This would allow the pre-filter to be attached to the other two, preferably similar, filter elements without a material connection and could be easily separated from them for recycling or simply to be replaced.

It is practical if the firmly connected filter elements together form a self-supporting air filter arrangement. Separate holders are therefore not required for positioning the air filter arrangement.

The disclosure moreover relates to a fan unit with a fan housing that forms an intake opening to which an air filter arrangement according to the disclosure is detachably attached. The air filter arrangement according to the disclosure can be attached directly to the intake opening of the fan housing without being received within a fan or filter housing. For example, a sealing element attached to the outlet side of the air filter arrangement forms a latching element that can be pressed into a depression formed at the intake opening on the fan housing in order to fasten the air filter arrangement to the fan housing with a desired holding force. A sealing effect already achieved by the assembly can be further reinforced during operation by the intake of air through the air filter arrangement, so that the air filter arrangement remains securely attached to the fan unit.

A fresh air system for a road construction machine, which is in the form of a road paver or a feed-er vehicle for a road paver, which has at least one fan unit with an air filter arrangement detachably attached thereto in accordance with the disclosure, would be expedient. The air filter arrangement forms a quickly and easily installable and removable unit for a fresh air system provided on the road paver or feeder vehicle.

It would be conceivable for the road construction machine to have a (driver's) seat console with a preferably pivotably mounted console base, on the underside of which the fan unit and the air filter arrangement attached to it are arranged. As a pivoting console, the console base is located out-side a driver's operating platform of the road construction machine when pivoted outwards, so that the air filter arrangement can be installed or removed in its entirety overhead by an operator positioned underneath.

It would be conceivable for the air filter arrangement according to the disclosure to be used in another fresh air system of the road construction machine, e.g., in a fresh air system of a control panel. For example, the air filter arrangement could be arranged behind a driver's control panel. With this arrangement, it is also preferred that the air filter arrangement according to the disclosure can be installed and removed in one piece. The used air filter arrangement can thereby simply be removed downwards from the fan unit. Conversely, a new air filter unit as a whole can easily be attached to the fan unit in place of the used air filter arrangement.

Furthermore, the disclosure relates to a method for replacing a plurality of used filter elements of a fresh air system provided on a road paver or on a feeder vehicle, which are used as filter elements acting in sequence for cleaning a bitumen-containing volume flow. The method according to the disclosure provides that the plurality of used filter elements are firmly connected to one an-other, removed together and a plurality of new, firmly connected filter elements are installed in their place. According to the disclosure, several filter elements can always be installed and re-moved at the same time and therefore do not need to be installed or removed as individual parts piece by piece. This enables simple installation and removal with just a few hand movements within a short time. The fact that the method according to the disclosure allows several filter elements to be installed and removed at once, that is, assembled in one piece, also means that proper use of the filter elements or proper installation of the filter elements can be achieved in a better way.

### BRIEF DESCRIPTION OF THE DRAWINGS

The disclosure is explained in more detail with reference to the embodiments shown in the following Figures:

FIG. 1 shows an air filter arrangement according to the disclosure;

FIG. 2 shows a road construction machine in the form of a road paver;

FIG. 3 shows a road construction machine in the form of a feeder vehicle for a road paver,

FIG. 4 shows a seat console with a fresh air device; and

FIG. 5 shows a control panel with a fresh air device.

Identical technical features are provided with the same reference signs throughout the Figures.

### DETAILED DESCRIPTION

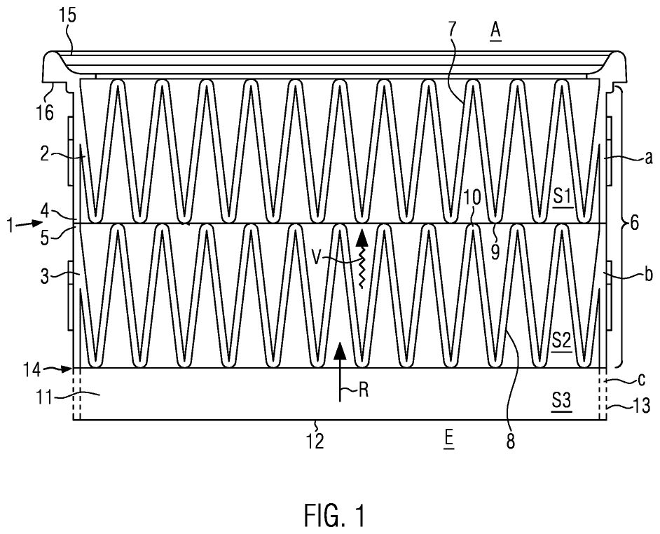

FIG. 1 shows an air filter arrangement 1 for cleaning a bitumen-containing volume flow V flowing in the direction R through the air filter arrangement 1. The air filter arrangement 1 has a first filter element 2 and a second filter element 3. The first and second filter elements 2, 3 are arranged directly above one another and have edges 4, 5 facing one another and firmly connected to one another. The edges 4, 5 of the two filter elements 2, 3 facing each other can, for example, be glued together in an airtight manner.

Outer wall sections a, b of the two filter elements 2, 3, which are firmly connected to each other, together form an airtight coating 6. This coating 6 extends essentially over the entire shell surface created by the two filter elements 2, 3.

In FIG. 1, the two filter elements 2, 3 are each in the form of activated carbon filters with a zig-zag-shaped filter mesh 7, 8. The tips 9, 10 of the two filter elements 2, 3 facing each other are offset next to each other in the direction R. This means that the respective tips 9 of the first filter element 2 lie between respective adjacent tips 10 of the second filter element 3 in the flow direction R and vice versa. This allows aerosols from the volume flow V to be bound more reliably in the filter mesh 7, 8 via the two filter elements 2, 3. This also means that the two filter elements 2, 3 wear more evenly.

FIG. 1 moreover shows that the air filter arrangement 1 comprises a third filter element 11 that serves as a pre-filter on the air filter arrangement 1. The third filter element 11 can, for example, be a foam filter with a smooth surface 12 that can be easily cleaned.

The third filter element 11 can be detachably or firmly connected to the other two filter elements 2, 3. It would be conceivable for the third filter element 11 to be clamped in a receptacle 13 by a press fit, wherein the receptacle 13 is formed by an extended wall section c of the central filter element 3. A purely form-fitting attachment of the pre-filter, for example to a tapered cross-section of the central filter element 3, would be conceivable as an alternative. Alternatively, the second, i.e., central filter element 3 can be formed without a receptacle 13 and the third filter element 11 is glued to it along an edge zone 14.

The air filter arrangement 1 also has a sealing element 15. In FIG. 1, the sealing element 15 is provided on an outlet side A of the air filter arrangement 1. It would be conceivable for a comparable sealing element 15 to be attached to an inlet side E of the air filter arrangement.

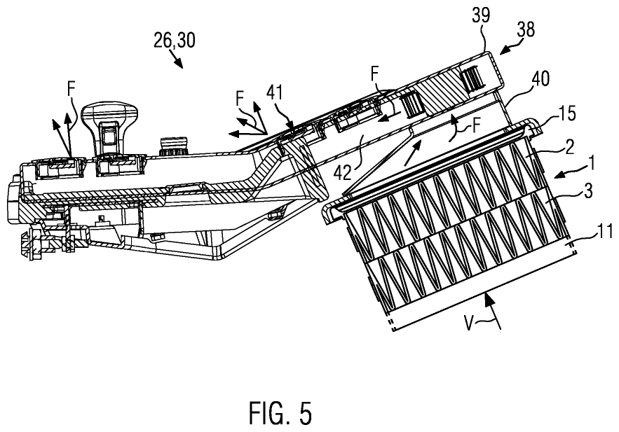

According to FIG. 1, the sealing element 15 is simultaneously present as a latching element with a projection 16, which serves as a latching means for fastening the sealing element 15 to a fan housing 40 (see FIG. 5).

According to FIG. 1, in the air filter arrangement 1 shown therein, the respective filter elements 2, 3, 11 are present as filter layers S1, S2, S3 arranged one above the other. The third filter element 11, which functions as a pre-filter at the lowest point, is configured as a coarse particle filter, for example. The filter layers S1, S2 arranged above it each form activated carbon fine particle filters. Together, filter elements 2, 3 and 11 act in sequence to clean the bitumen-containing volume flow V in the direction R.

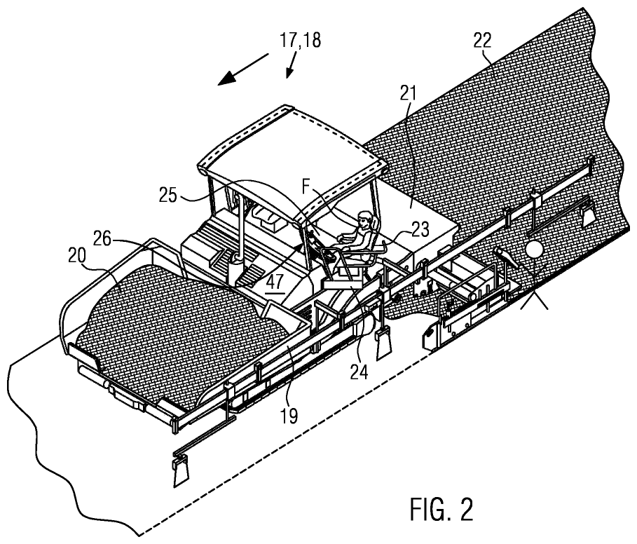

FIG. 2 shows a road construction machine 17 in the form of a road paver 18. The road paver 18 is configured to produce a new paving layer 22 from a paving material 20 stored within a hopper 19 by means of its paving screed 21. The road paver 18 of FIG. 2 is controlled by a driver F. The driver F sits on a swiveled-out driver's seat console 23, which has a swivel-out console base 24. In FIG. 2, this console base 24 is positioned laterally swiveled out over a driver's operating platform 25. The driver F uses a driver's control panel 26 to control the operation of the road paver 18.

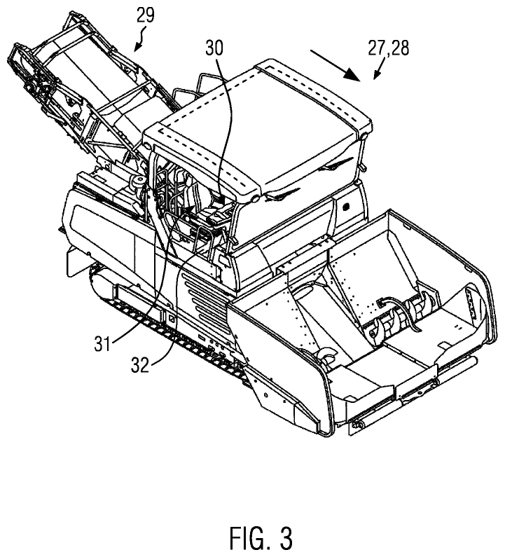

FIG. 3 shows a further road construction machine 27 configured in the form of a feeder vehicle 28. Such a feeder vehicle 28 is used in practice to supply a road paver 18 as shown in FIG. 2 with paving material 20. For this purpose, the feeder vehicle 28 travels in front of the road paver 18 in the direction of travel and throws paving material 20 into the hopper 19 of the road paver 18 following behind it by means of a conveyor device 29 formed on the feeder vehicle 28.

According to FIG. 3, the feeder vehicle 28 has a driver's control panel 30, behind which a seat console 31 with a pivotably mounted console base 32 is positioned. In FIG. 3, the driver's control panel 30 is positioned behind a windshield of the feeder vehicle 28, however, together with the seat console 31, it can be brought into a position next to the driver's operating station, i.e., it can be pivoted beyond its driver's operating platform, like the seat console 23 as shown in FIG. 2.

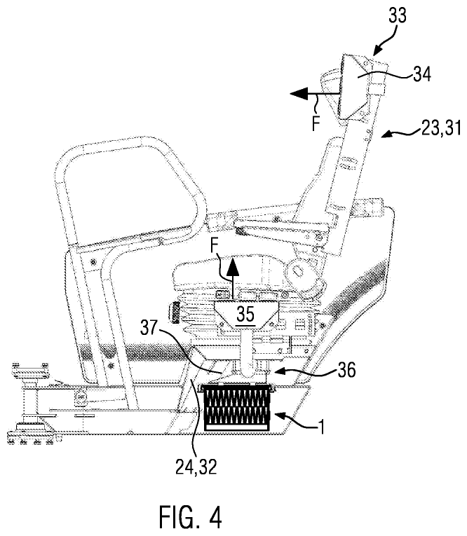

FIG. 4 shows the (driver's) seat console 23, 31 in an isolated view. The (driver's) seat console 23, 31 comprises a fresh air system 33 with a plurality of nozzle units 34, 35 provided on both sides of the (driver's) seat console 23, 31. Below the console base 24, 32, a fan unit 36 is mounted on an underside of the console base 24, 32. The air filter arrangement 1 is attached to the fan unit 36. The fan unit 36 and the air filter arrangement 1 are received within a step 37 formed by the console base 24, 32.

In the swiveled-out position of the driver's seat console 23 shown in FIG. 2, an operator can remove overhead the air filter arrangement 1 in one piece from underneath the driver's seat console 23 and replace it with a new air filter arrangement 1.

FIG. 5 shows the driver's control panel 26, 30 in an isolated view with a fresh air system 38 attached to it, which has a fan unit 39 to the fan housing 40 of which the air filter arrangement 1 is attached. In this position, too, the one-piece structure of the air filter arrangement 1 is very advantageous for installation and removal.

What is claimed is:

1. An air filter arrangement for cleaning a bitumen-containing volume flow, comprising at least a first filter element and a second filter element, which are arranged as filter elements to act in succession for cleaning the bitumen-containing volume flow, wherein the first filter element and the second filter element are firmly connected to one another.

2. The air filter arrangement according to claim 1, wherein the first filter element and the second filter element are connected to one another by a material-bonded, form-fit and/or force-fit connection.

3. The air filter arrangement according to claim 1, wherein the first filter element and the second filter element are glued to one another.

4. The air filter arrangement according to claim 1, wherein the first filter element and/or the second filter element have/has a zigzag-shaped, undulating, rectangular, nub-shaped or pyramid-shaped filter mesh.

5. The air filter arrangement according to claim 1, wherein at least one of the first filter element or the second filter element is an activated carbon filter.

6. The air filter arrangement according to claim 1, wherein the air filter arrangement comprises a third filter element as a pre-filter, which is firmly or detachably connected to the first and second filter elements.

7. The air filter arrangement according to claim 6, wherein the third filter element is glued to the second filter element.

8. The air filter arrangement according to claim 6, wherein the third filter element has a smooth surface.

9. The air filter arrangement according to claim 6, wherein the third filter element comprises a foam filter or a fleece filter.

10. The air filter arrangement according to claim 1, wherein the filter elements are present as filter layers arranged one above the other.

11. The air filter arrangement according to claim 1, wherein the air filter arrangement forms an inlet side and an outlet side, wherein a sealing element is provided on the inlet side and/or on the outlet side.

12. The air filter arrangement according to claim 11, wherein the sealing element is configured as a latching element for tool-free attachment to a fan housing.

13. The air filter arrangement according to claim 1, wherein the filter elements, which are firmly connected to one another, together form an airtight coating.

14. The air filter arrangement according to claim 1, wherein the filter elements, which are firmly connected to one another, together form a self-supporting air filter arrangement.

15. A fan unit having a fan housing which forms an intake opening to which the air filter arrangement according to claim 1 is detachably fastened.

16. A fresh air system for a road paver, which is configured as a road paver or a feeder vehicle for a road paver, comprising at least one fan unit according to claim 15.

17. A method for replacing a plurality of used filter elements of a fresh air system provided on a road paver or on a feeder vehicle, which are used as filter elements acting in succession for cleaning a bitumen-containing volume flow, the method comprising:
removing together the plurality of used filter elements, which are firmly connected to one another; and
installing a plurality of new, firmly connected filter elements in place of the plurality of used filter elements.
